(19) United States
(12) Patent Application Publication
(10) Pub. No.: US 2024/0361965 A1
(43) Pub. Date: Oct. 31, 2024

(54) MOBILE TERMINAL APPARATUS, IMAGE PROCESSING APPARATUS, AND PROGRAM

(71) Applicant: KYOCERA CORPORATION, Kyoto-shi (JP)

(72) Inventors: Hiroshi OKA, Kyoto-shi (JP); Ayato YONEDA, Kirishima-shi (JP); Shingo ITO, Kyoto-shi (JP)

(21) Appl. No.: 18/757,508

(22) Filed: Jun. 28, 2024

Related U.S. Application Data
(63) Continuation of application No. PCT/JP2023/016910, filed on Apr. 28, 2023.

(51) Int. Cl. G06F 3/12

(52) U.S. Cl. CPC G06F 3/1292; G06F 3/1203; G06F 3/1253

(57) ABSTRACT

A mobile terminal apparatus includes: a communicator configured to communicate with an image processing apparatus configured to perform image processing; a controller configured to execute a plurality of applications including a first application related to the image processing and a second application not related to the image processing; and a display configured to display an image corresponding to an application being executed out of the plurality of applications. The first application includes an operation application used for operation of the image processing. In a communication state in which communication connection between the communicator and the image processing apparatus is established, the controller restricts display of an image corresponding to the second application.

### RELATED APPLICATION

The present application is a continuation of PCT Application No. PCT/JP2023/016910, filed on Apr. 28, 2023, the content of which is incorporated by reference herein in its entirety.

### TECHNICAL FIELD

The present disclosure relates to a mobile terminal apparatus, an image processing apparatus, and a program.

### BACKGROUND OF INVENTION

Patent Document 1 describes an image processing cooperative system that causes a mobile terminal apparatus to display an operation screen of an image processing apparatus, and operates the image processing apparatus from the mobile terminal apparatus.

In the image processing cooperative system, the image processing apparatus transmits remote screen display data to the mobile terminal apparatus. Using the remote screen display data, the mobile terminal apparatus displays a remote screen with which the image processing apparatus can be remotely operated. Thus, when a user touches and operates the remote screen displayed in the mobile terminal apparatus, the image processing apparatus can be remotely operated from the mobile terminal apparatus.

### CITATION LIST

### Patent Literature

Patent Document 1: JP 2014-219706 A

### SUMMARY

In a first aspect of the present disclosure, a mobile terminal apparatus includes: a communicator configured to communicate with an image processing apparatus configured to perform image processing; a controller configured to execute a plurality of applications comprising a first application related to the image processing and a second application not related to the image processing; and a display configured to display an image corresponding to an application being executed out of the plurality of applications, wherein the first application comprises an operation application used for operation of the image processing, and in a communication state in which communication connection between the communicator and the image processing apparatus is established, the controller restricts display of an image corresponding to the second application.

In a second aspect of the present disclosure, an image processing apparatus includes: a communicator configured to communicate with a mobile terminal apparatus configured to execute a plurality of applications comprising a first application related to image processing and a second application not related to the image processing; an image processor configured to execute the image processing, based on a user operation on the mobile terminal apparatus; and a controller configured to control the communicator to transmit, to the mobile terminal apparatus, information for restricting display of an image corresponding to the second application for the mobile terminal apparatus, in a communication state in which communication connection with the mobile terminal apparatus is established by the communicator.

In a third aspect of the present disclosure, a program is a program causing a mobile terminal apparatus to execute: communicating with an image processing apparatus configured to perform image processing; executing any of a plurality of applications comprising a first application and a second application, the first application being an application related to the image processing and comprising an operation application used for operation of the image processing, and the second application being not related to the image processing; displaying an image corresponding to an application being executed out of the plurality of applications; and in a communication state in which communication connection with the image processing apparatus is established, restricting display of the image corresponding to the second application.

### BRIEF DESCRIPTION OF THE DRAWINGS

FIG. 1 is a diagram illustrating a configuration example of an operation support system according to an embodiment.

FIG. 2 is a diagram illustrating a configuration example of an operation panel according to an embodiment.

FIG. 3 is a diagram illustrating an example of a part in which a mobile terminal apparatus is leaned against an image processing apparatus according to an embodiment.

FIG. 4 is a diagram illustrating a configuration example in which the mobile terminal apparatus is held vertically against the image processing apparatus according to an embodiment.

FIG. 5 is a diagram illustrating a configuration example in which the mobile terminal apparatus is held horizontally against the image processing apparatus according to an embodiment.

FIG. 6 is a diagram illustrating a configuration example of the image processing apparatus according to an embodiment.

FIG. 7 is a diagram illustrating a configuration example of the mobile terminal apparatus according to an embodiment.

FIG. 8 is a flowchart illustrating a first operation example of restricting display of an image corresponding to a second application in a communication state in which communication connection between a communicator of the mobile terminal apparatus and the image processing apparatus is established according to an embodiment.

FIG. 9 is a flowchart illustrating a second operation example of restricting display of the image corresponding to the second application in the communication state in which communication connection between the communicator of the mobile terminal apparatus and the image processing apparatus is established according to an embodiment.

FIG. 10 is a flowchart illustrating a third operation example of restricting display of the image corresponding to the second application in the communication state in which communication connection between the communicator of the mobile terminal apparatus and the image processing apparatus is established according to an embodiment.

FIG. 11 is a flowchart illustrating a fourth operation example of restricting display of the image corresponding to the second application in the communication state in which communication connection between the communicator of the mobile terminal apparatus and the image processing apparatus is established according to an embodiment.

FIGS. 12A to 12D are diagrams illustrating a transition example of display screens of the mobile terminal apparatus according to an embodiment.

FIG. 13 is a diagram illustrating an example of the display screen in the communication state in which connection between the mobile terminal apparatus and the image processing apparatus is established according to an embodiment.

FIG. 14 is a diagram illustrating another example of the display screen in the communication state in which connection between the mobile terminal apparatus and the image processing apparatus is established according to an embodiment.

FIG. 15 is a diagram illustrating an example of the display screen when a notification condition is satisfied in a non-communication state in which connection between the mobile terminal apparatus and the image processing apparatus is not established according to an embodiment.

FIG. 16 is a diagram illustrating an example of the display screen when the notification condition is satisfied in the communication state in which connection between the mobile terminal apparatus and the image processing apparatus is established according to an embodiment.

FIG. 17 is a flowchart illustrating an operation example of the operation support system according to an embodiment.

FIG. 18 is a flowchart illustrating an operation example of an image processing apparatus according to a variation of an embodiment.

FIG. 19 is a diagram illustrating another example of the display screen when the notification condition is satisfied in a state in which the mobile terminal apparatus is connected to the image processing apparatus according to a variation of an embodiment.

FIG. 20 is a flowchart illustrating an operation example of the mobile terminal apparatus according to a variation of an embodiment.

FIG. 21 is a flowchart illustrating another operation example of the mobile terminal apparatus according to a variation of an embodiment.

### DESCRIPTION OF EMBODIMENTS

An operation support system including a mobile terminal apparatus and an image processing apparatus according to an embodiment will be described below with reference to the drawings. In the description of the drawings, the same or similar parts are denoted by the same or similar reference signs.

### (1) Overview of Embodiments

A mobile terminal apparatus may be used by a person other than an owner of the mobile terminal apparatus to operate an image processing apparatus. In such a case, for example, when an image of an application not related to image processing is displayed in the mobile terminal apparatus as an image of a notification or the like for the owner, privacy of the owner may be violated. Thus, conventional technology for operating the image processing apparatus using the mobile terminal apparatus has room for improvement from the viewpoint of security of information.

In the present disclosure, a mobile terminal apparatus includes: a communicator configured to communicate with an image processing apparatus configured to perform image processing; a controller configured to execute a plurality of applications including a first application related to the image processing and a second application not related to the image processing; and a display configured to display an image corresponding to an application being executed out of the plurality of applications. The first application includes an operation application used for operation of the image processing. In a communication state in which communication connection between the communicator and the image processing apparatus is established, the controller restricts display of the image corresponding to the second application.

### (2) System Configuration Example

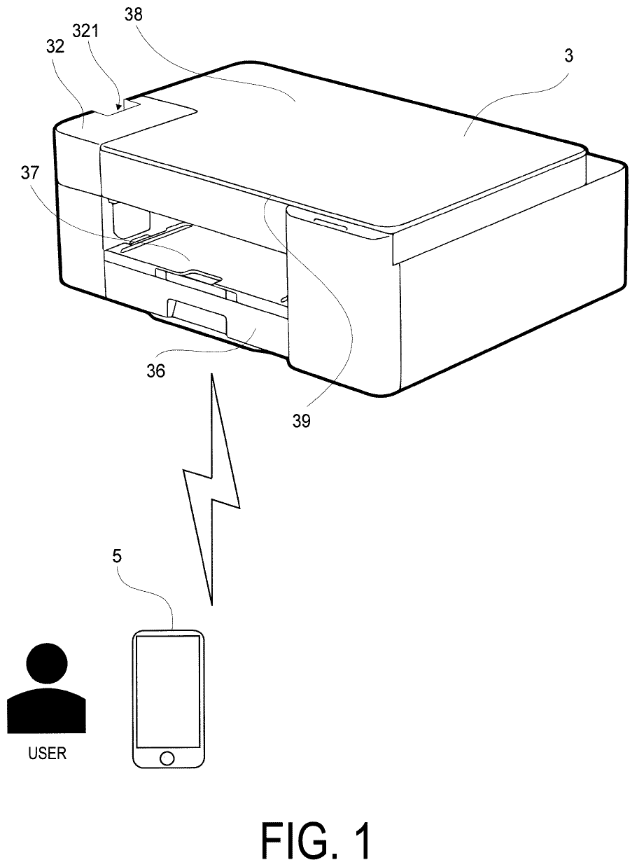

FIG. 1 is a diagram illustrating a configuration example of an operation support system according to an embodiment. The operation support system according to the present embodiment includes an image processing apparatus 3 (also referred to as a “printer”) and a mobile terminal apparatus 5.

The image processing apparatus 3 is an apparatus that executes image processing including printing. The image processing apparatus 3 may be able to execute image processing other than printing, for example, scanning. The image processing apparatus 3 has a function of performing communication with the mobile terminal apparatus 5. The present embodiment will mainly describe an example in which the image processing apparatus 3 communicates with the mobile terminal apparatus 5 via wireless communication; however, the image processing apparatus 3 may communicate with the mobile terminal apparatus 5 via wired communication. Note that, in the illustrated example, the image processing apparatus 3 is a small home printer. However, the image processing apparatus 3 may be a large multi-function printer (MFP) installed at an office or a store.

Printing operation performed by the image processing apparatus 3 is operation at least including printing. The printing operation includes “print”, in which the mobile terminal apparatus 5 transmits print data (image data) to the image processing apparatus 3, and the image processing apparatus 3 performs printing thereof. The printing operation includes “copy”, in which the image processing apparatus 3 performs printing of scanned data (image data) obtained by scanning.

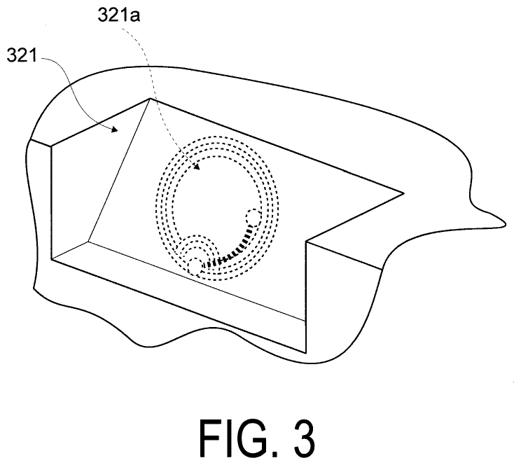

In the illustrated example, the image processing apparatus 3 includes a sheet feed tray 36, a sheet discharge tray 37, an original table cover 38, and an original table 39. Sheets being set in the sheet feed tray 36 are conveyed to a printer 31a (not illustrated in FIG. 1; see FIG. 3) one by one, printing is performed in the printer 31a, and the sheets are delivered from the sheet delivery tray 37. The original table cover 38 is capable of opening upward with an end portion of the original table 39 being a fulcrum, allows a sheet to be placed on the original table 39 while the original table cover 38 is open, and allows scanning to be performed while the original table cover 38 is open or the original table cover 38 is closed. An operation panel 32 is provided at a corner of the image processing apparatus 3 on an upper surface. Although details of the operation panel 32 will be described later, the operation panel 32 receives various operations related to the image processing apparatus 3 from a user. The operation panel 32 is provided with a cutout portion 321. The mobile terminal apparatus 5 may be leaned against the cutout portion 321, and various operations related to the image processing apparatus 3 from the user may be received from the mobile terminal apparatus 5.

The mobile terminal apparatus 5 is an apparatus capable of operating the image processing apparatus 3 via communication with the image processing apparatus 3. The mobile terminal apparatus 5 may be a mobile terminal, for example, a smartphone, a tablet terminal, a laptop computer (PC), or the like. The mobile terminal apparatus 5 moves along with movement of the user.

The mobile terminal apparatus 5 is capable of executing a plurality of applications. The plurality of applications include a first application related to image processing of the image processing apparatus 3 and a second application not related to image processing of the image processing apparatus 3. The first application includes an operation application used for operation of image processing of the image processing apparatus 3. The mobile terminal apparatus 5 displays an execution screen of an application being executed out of the plurality of applications. Although details will be described later, the execution screen of the operation application is displayed as an execution screen as a mobile application for operating the image processing apparatus 3, for example. Note that examples of the first application include a document application, a picture application, an email application, and a browser application. On the other hand, examples of the second application include a clock application, a weather forecast application, and a chat application.

At an edge portion of the operation panel 32, the cutout portion 321 may be provided. Although details will be described later, the cutout portion 321 is provided as a portion for allowing the mobile terminal apparatus 5 to be leaned against. When the mobile terminal apparatus 5 is leaned against the cutout portion 321 and the mobile terminal apparatus 5 and the image processing apparatus 3 are connected via a wired medium or a wireless medium, the mobile terminal apparatus 5 can be caused to display the execution screen of the operation application. Thus, even if the image processing apparatus 3 does not have a configuration of displaying an operation screen, the mobile terminal apparatus 5 can be used as the operation screen of the image processing apparatus 3.

### (3) Configuration Example of Operation Panel 32

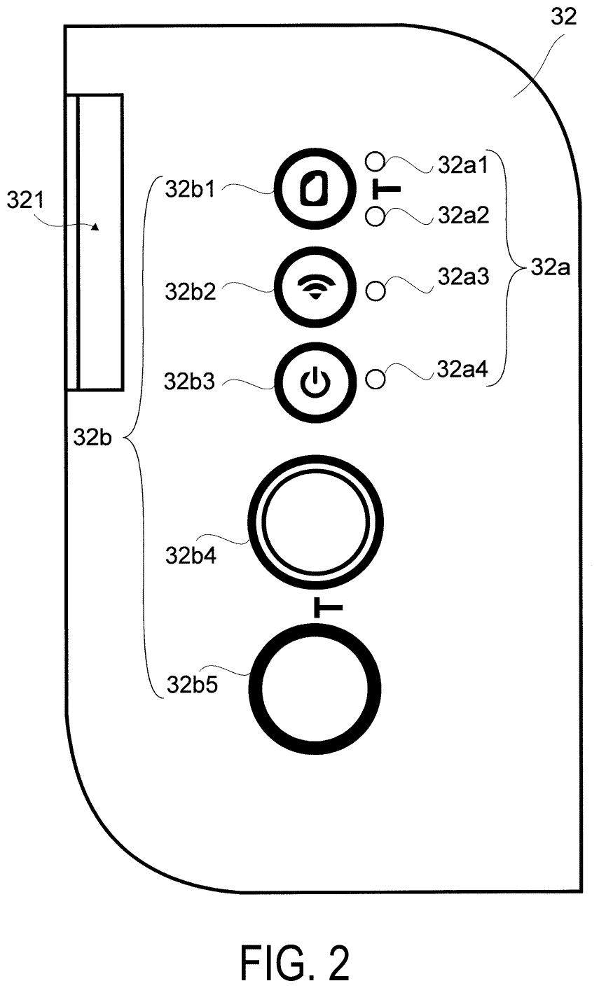

FIG. 2 is a diagram illustrating a configuration example of the operation panel 32 according to an embodiment. The operation panel 32 has a function of receiving operation of the user (input of the user). The operation panel 32 includes a display 32a and an operation inputter 32b. For example, the display 32a includes lamps 32a1 and 32a2 for indicating settings of a sheet, such as a selected sheet size and a sheet type, a lamp 32a3 for indicating a state of a wireless network, and a lamp 32a4 for indicating a state of power. In the following, unless one of the lamps 32a1, 32a2, 32a3, or 32a4 is particularly specified, a term “lamp” is used. Each lamp includes a light emitting diode (LED), for example. The operation inputter 32b includes a button 32b1 for receiving settings of a sheet, a button 32b2 for receiving wireless settings, a button 32b3 for enabling setting of power to an ON-state or an OFF-state, a button 32b4 for starting monochrome copy for forming a monochrome image or a grayscale image on a sheet, and a button 32b5 for starting color copy for forming a color image on a sheet. In the following, unless one of the buttons 32b1, 32b2, 32b3, 32b4, or 32b5 is particularly specified, a term “button” is used. Note that the operation panel 32 may include a touch panel display, in which a touch panel as the operation inputter 32b overlaps a liquid crystal display as the display 32a. Note that FIG. 2 illustrates an example in which the cutout portion 321 is provided at a left edge of the operation panel 32.

### (4) Configuration Example of Cutout Portion 321

FIG. 3 is a diagram illustrating an example of a part in which the mobile terminal apparatus 5 is leaned against the image processing apparatus 3 according to an embodiment. As illustrated in FIG. 3, a near field communication (trade name; NFC) antenna 321a is embedded in the cutout portion 321. Thus, when the mobile terminal apparatus 5 equipped with the function of NFC is leaned against the cutout portion 321, the mobile terminal apparatus 5 can perform communication with the image processing apparatus 3 via the NFC antenna 321a. This thus enables communication between the mobile terminal apparatus 5 and the image processing apparatus 3 via the NFC antenna 321a, and accordingly the mobile terminal apparatus 5 can be caused to display the execution screen of a printer operation application. Using the communication via the NFC antenna 321a, information (an SSID or the like) necessary for Wi-Fi communication connection may be transmitted and received between the mobile terminal apparatus 5 and the image processing apparatus 3. Then, the mobile terminal apparatus 5 and the image processing apparatus 3 may establish Wi-Fi communication connection, and the Wi-Fi communication may enable the mobile terminal apparatus 5 to display the execution screen of the printer operation application. In the cutout portion 321, a Bluethooth (trade name) antenna may be embedded. In this case, when the mobile terminal apparatus 5 equipped with a Bluetooth antenna is leaned against the cutout portion 321 and after pairing is performed, various signals may be transmitted and received between the mobile terminal apparatus 5 and the image processing apparatus 3. Thus, the Bluetooth communication may enable the mobile terminal apparatus 5 to display the execution screen of the printer operation application.

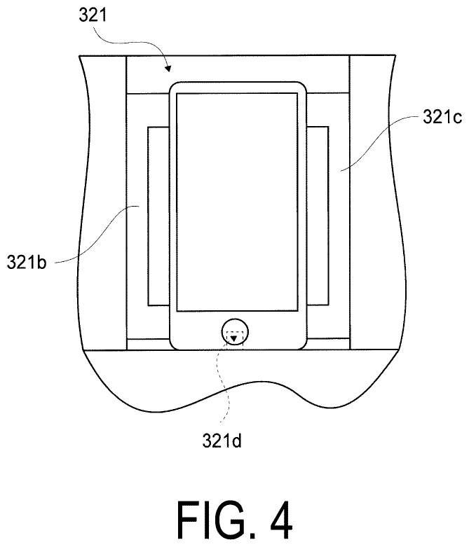

FIG. 4 is a diagram illustrating a configuration example in which the mobile terminal apparatus 5 is held vertically against the image processing apparatus 3 according to an embodiment. In an example of FIG. 4, the mobile terminal apparatus 5 is held by holding parts 321b and 321c while the mobile terminal apparatus 5 is held vertically against the cutout portion 321 and a connection terminal 321d is inserted into a bottom portion of the mobile terminal apparatus 5 to allow electrical connection. Specifically, from the left side of the cutout portion 321, the holding part 321b holds an upper side and a lower side of the mobile terminal apparatus 5 at a left edge, and avoids pressing on a volume adjustment button, for example. From the right side of the cutout portion 321, the holding part 321c holds an upper side and a lower side of the mobile terminal apparatus 5 at a right edge, and avoids pressing on a power button, for example. Note that the holding parts 321b and 321c may rotate by 90 degrees, and the mobile terminal apparatus 5 may be held with the mobile terminal apparatus 5 being positioned horizontally. In this case, the connection terminal 321d itself may rotate by 90 degrees as well, and a cord of the connection terminal 321d on a terminal side may be extended.

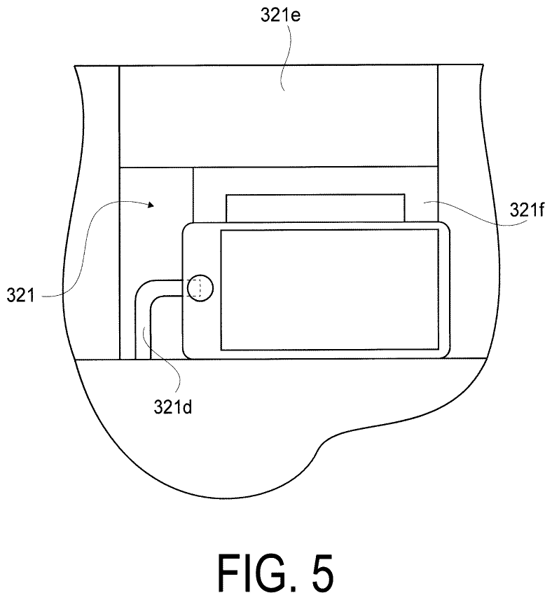

FIG. 5 is a diagram illustrating a configuration example in which the mobile terminal apparatus 5 is held horizontally against the image processing apparatus 3 according to an embodiment. In an example of FIG. 5, the mobile terminal apparatus 5 is held by holding parts 321e and 321f while the mobile terminal apparatus 5 is held horizontally against the cutout portion 321 and the connection terminal 321d is inserted into the bottom portion of the mobile terminal apparatus 5 to allow electrical connection. Specifically, the holding part 321f holds an upper side and a lower side of the mobile terminal apparatus 5 at a left edge. The holding part 321e holds a back side of the holding part 321f.

### (5) Configuration Example of Image Processing Apparatus 3

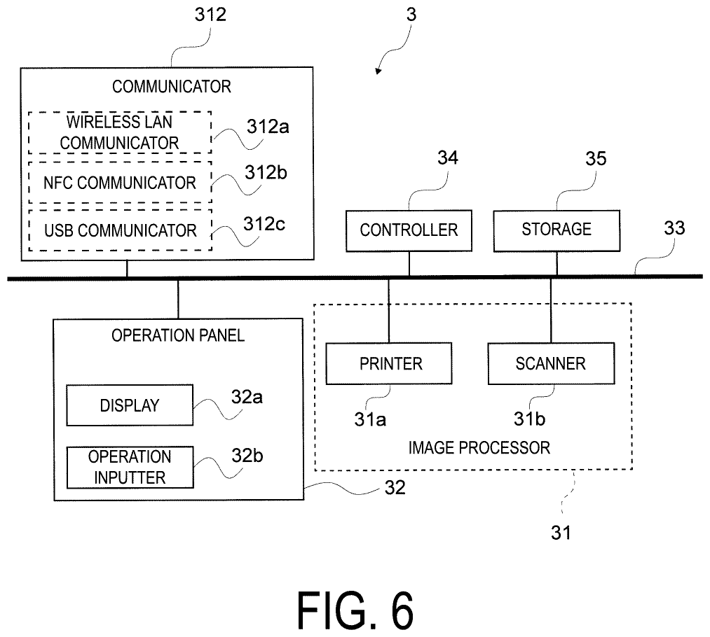

FIG. 6 is a diagram illustrating a configuration example of the image processing apparatus 3 according to an embodiment. As illustrated in FIG. 6, the image processing apparatus 3 includes the printer 31a, a scanner 31b, the operation panel 32, a controller 34, a storage 35, and a communicator 312. The image processing apparatus 3 has a configuration capable of performing one or more types of image processing. In the present disclosure, as a configuration for performing image processing, the printer 31a and the scanner 31b are provided. The printer 31a and the scanner 31b configure the image processor 31. Note that the image processing apparatus 3 may have a configuration of including only one of the printer 31a or the scanner 31b.

In the present disclosure, types of image processing executed by the image processor 31 include “print”, “copy”, and “scan”. In other words, the image processing apparatus 3 has functions of “print”, “copy”, and “scan”. Note that, although illustration is omitted, the image processing apparatus 3 may have functions of sheet post-processing steps, such as stapling, punching, sorting, and trimming, in addition to the functions described above.

“Copy” is a function of allowing an image scanned by the scanner 31b to be printed on a sheet in the printer 31a. “Print” is a function of allowing an image based on data received by the communicator 312 from outside or an image based on data stored in a recording medium (not illustrated) connected to the image processing apparatus 3 to be printed in the printer 31a. “Scan” is a function of storing an image scanned by the scanner 31b as data. For example, a storage destination is an auxiliary storage apparatus (a non-volatile memory from another viewpoint) included in the storage 35, a storage medium connected to the image processing apparatus 3, or another device that performs communication with the image processing apparatus 3 via the communicator 312.

The image processor 31 may not need to support all of these functions. The image processing apparatus 3 may support only one or only two of the functions of “print”, “copy”, and “scan”, for example. The image processor 31 may further support a function of “email”. “Email” is a function of performing settings and execution related to email. With the function of “email”, for example, a part or all of contents of an email received by the communicator 312 may be printed by the printer 31a, or data of an image scanned by the scanner 31b may be transmitted by the communicator 312 via email.

The printer 31a performs image printing under control of the controller 34. For example, the printer 31a performs printing on a sheet arranged on the sheet feed tray 36 illustrated in FIG. 1, and delivers a printed sheet to the sheet discharge tray 37. Specifically, for example, if the printer 31a is configured as a laser printer, toner images of respective colors, i.e., yellow (Y), magenta (M), cyan (C), and black (K), formed on a photosensitive drum are primarily transferred to an intermediate transfer belt, the toner images of the four colors are superimposed on the intermediate transfer belt and are then secondarily transferred to a sheet to form an image on the sheet, and the sheet with the image formed thereon is delivered to the sheet discharge tray 37.

Note that, although the above has described an example in which the printer 31a forms a color image on a sheet, this is not particularly restrictive. For example, the printer 31a may have a configuration capable of forming a monochrome image or a grayscale image on a sheet. The printer 31a may be configured as an inkjet printer. Although in an example of FIG. 1, the printer 31a includes only one sheet feed tray 36, this is not particularly restrictive. For example, the printer 31a may include a plurality of sheet feed trays 36. If the printer 31a includes a plurality of sheet feed trays 36, for example, sheets of different sizes can be accommodated in the plurality of sheet feed trays 36. One sheet feed tray 36 may be provided with partitioning plate(s), and the partitioning plate(s) may allow accommodation of sheets of different sizes. The printer 31a may have a function of selecting a size of a sheet.

The scanner 31b performs image scanning under control of the controller 34, and generates image data. Specifically, the scanner 31b performs imaging (scanning), which is performed by an imaging device that moves along an original glass, on an original placed on the original table 39 with the original table cover 38 illustrated in FIG. 1 being closed, and generates image data.

The communicator 312 performs communication with the mobile terminal apparatus 5. The communicator 312 includes at least one selected from the group consisting of a wireless LAN communicator 312a, an NFC communicator 312b, and a USB communicator 312c. The wireless LAN communicator 312a performs wireless communication of a wireless LAN communication method with the mobile terminal apparatus 5. The NFC communicator 312b performs wireless communication of an NFC method with the mobile terminal apparatus 5. The NFC communicator 312b performs the wireless communication of the NFC method in conjunction with the NFC antenna 321a of FIG. 3. The USB communicator 312c performs communication of a USB method with the mobile terminal apparatus 5 via the connection terminal 321d of FIG. 4 or FIG. 5. Note that, although FIG. 1 illustrates an example in which the operation support system includes the image processing apparatus 3 and the mobile terminal apparatus 5, the operation support system may further include a server, such as a file server, an email server, and a Web server. In this case, the communicator 312 is also capable of communicating with the server, such as the file server, the email server, and the Web server.

The controller 34 includes one or more processors, and controls the entire image processing apparatus 3. The controller 34 executes various types of processing by executing a control program stored in the storage 35. The controller 34 controls operations of the printer 31a, the scanner 31b, the communicator 312, and the operation panel 32. For example, when the controller 34 receives an operation (instruction) of the user via the operation inputter 32b, the controller 34 executes processing in accordance with operation details corresponding to the operation. Each lamp constituting the display 32a indicates operation details corresponding to various operations in accordance with an instruction from the controller 34. For example, when the communicator 311 is connected with the mobile terminal apparatus 5 via a wireless medium, the lamp 32a3 maintains a lighting state. Note that the controller 34 may include a logic circuit or the like configured to perform only a certain operation.

For example, the storage 35 includes various memories such as a read only memory (ROM), a random access memory (RAM), and an auxiliary storage apparatus. Note that a combination of the controller 34 and the storage 35 may be considered as a computer. The program to be executed by the controller 34 is stored in various memories of the storage 35, such as the ROM and the auxiliary storage apparatus, for example.

The printer 31a, the scanner 31b, the communicator 312, the operation panel 32, the controller 34, and the storage 35 are connected by a bus 33, for example. In FIG. 6, all of the components are schematically connected to one bus 33, but a plurality of buses 33 may be present. For example, as the plurality of buses 33, an address bus, a data bus, and a control bus may be provided.

Note that, as an external appearance of the image processing apparatus 3, FIG. 1 illustrates an example of an external appearance of a multi-function printer for home or personal use, instead of an external appearance of a multi-function printer for business use. However, the image processing apparatus 3 may be used in any manner. For example, the image processing apparatus 3 may be installed in a company and used by a plurality of specific users, or may be installed in a store, such as a supermarket or a convenience store, and used by a plurality of unspecified users.

### (6) Configuration Example of Mobile Terminal Apparatus 5

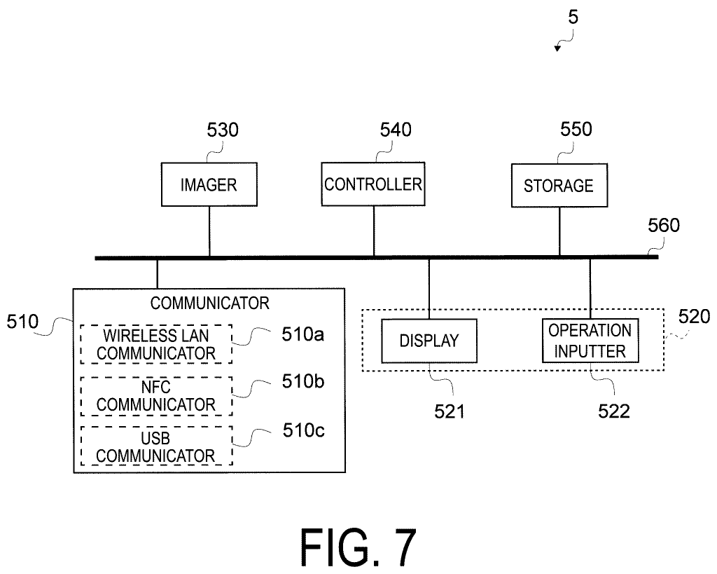

FIG. 7 is a diagram illustrating a configuration example of the mobile terminal apparatus 5 according to an embodiment. The mobile terminal apparatus 5 includes a communicator 510, a display 521, an operation inputter 522, an imager 530, a controller 540, and a storage 550. The mobile terminal apparatus 5 may not need to include the imager 530. The mobile terminal apparatus 5 further includes a power supply, which is not illustrated. The power supply may include a battery.

The communicator 510 performs communication with the image processing apparatus 3. The communicator 510 includes at least one selected from the group consisting of a wireless LAN communicator 510a, an NFC communicator 510b, and an USB communicator 510c. The wireless LAN communicator 510a performs wireless communication of a wireless LAN communication method with the image processing apparatus 3. The NFC communicator 510b performs wireless communication of an NFC method with the image processing apparatus 3. The USB communicator 510c performs wireless communication of a USB method with the image processing apparatus 3. Note that the mobile terminal apparatus 5 may further include a public network communicator that performs communication via a public network. The public network may include a cellular communication network. A public communication network may be a cellular communicator.

The display 521 displays an image under control of the controller 540. The operation inputter 522 receives user operation (user input). The display 521 includes a liquid crystal display or an organic EL display. At least a part of the operation inputter 522 may be integrated with the display 521 to configure a touch panel display 520. The following will mainly describe an example in which the display 521 and the operation inputter 522 configure the touch panel display 520. Note that at least a part of the operation inputter 522 may be configured as one or more physical buttons. The operation inputter 522 detects a position of a touch operation on the display 521, and outputs detection results.

The imager 530 configures a camera including an image sensor, such as a charge coupled device (CCD) or a complementary metal oxide semiconductor (CMOS). The imager 530 electronically captures an image under control of the controller 540, and outputs image data.

The controller 540 includes one or more processors, and controls the entire mobile terminal apparatus 5. For example, the controller 540 executes various types of processing and various types of control by executing a program stored in the storage 550. The program includes the printer operation application (also simply referred to as an “operation application”) for operating the image processing apparatus 3. The controller 540 may include a logic circuit or the like configured to perform only a certain operation. The operation of the mobile terminal apparatus 5 described above and below may be operation performed under control of the controller 540.

For example, the storage 550 includes various memories such as a ROM, a RAM, and an auxiliary storage apparatus. A combination of the controller 540 and the storage 550 may be considered as a computer. The program to be executed by the controller 540 is stored in the ROM and/or the auxiliary storage apparatus of the storage 550, for example.

Each part of the mobile terminal apparatus 5 is electrically connected by a bus 560. In the illustrated example, all of the components are schematically connected to one bus 560, but a plurality of buses, for example, an address bus, a data bus, and a control bus, may be provided. An interface may be interposed between the bus 560 and each part.

In the mobile terminal apparatus 5 according to an embodiment, the storage 550 may store personal information, which is information for allowing identification of a specific individual. For example, the personal information is address information, such as an email address. The address information may be managed by the second application. The display 521 can display the execution screen of an application being executed out of the first application and the second application. The controller 540 can execute each of the plurality of applications.

In the mobile terminal apparatus 5 according to an embodiment, the communicator 510 communicates with the image processing apparatus 3 that performs image processing. The controller 540 can execute a plurality of applications including the first application related to image processing and the second application not related to image processing. The first application includes the operation application used for operation of image processing. The display 32a displays an image corresponding to an application being executed out of the plurality of applications. In a communication state in which communication connection between the communicator 510 and the image processing apparatus 3 is established, the controller 540 restricts display of an image corresponding to the second application.

Here, for example, the image corresponding to the second application is at least one selected from the group consisting of an icon of the second application, an execution screen of the second application, and a notification object of the second application.

For example, “to restrict display” may mean allowing no display, may be to perform limited display, or may be to permit display only when user authentication (password input) is requested and the authentication succeeds. For example, “to restrict display of the image corresponding to the second application” may be to allow no display of the icon of the second application, may be to allow no display of the execution screen of the second application, or may be to allow no display of the notification object of the second application.

According to the mobile terminal apparatus 5 according to an embodiment, even when a person other than an owner of the mobile terminal apparatus 5 operates the image processing apparatus 3 using the mobile terminal apparatus 5, display of the image corresponding to the second application not related to image processing is limited, and therefore security of information of the owner can be secured.

The first application includes applications that handle image data as a printing target of the image processing apparatus 3 (for example, a document application, a picture application, an email application, and a browser application). In the communication state in which communication connection between the communicator 510 and the image processing apparatus 3 is established, the controller 540 may restrict display of the image corresponding to the second application without limiting display of the image corresponding to the first application. According to such an operation example, display of the image of the application that handles the image data as the printing target is not limited, and therefore the image data as the printing target can be selected, for example, and reduction of convenience for the user can be avoided.

Note that, as selection of an image processing target to be subjected to image processing by the operation application, for example, the following can be performed.

Firstly, a related first application may be accessed (referred to) on the execution screen of the operation application. For example, “print” displayed on the execution screen may be selected, and subsequently an icon indicating a “printing target” may be selected, and a specific first application appropriate for the “printing target” selected out of a list of the related first applications may be selected, and the image to be processed in the operation application may thereby be selected (first configuration).

Secondly, in the operation application, a dedicated folder in which the image data of the related first application is aggregated in advance may be created (second configuration).

Employing the first and second configurations can make it less likely that a person other than the owner of the mobile terminal apparatus 5 accidentally transitions to a home screen or activates the second application from the home screen in order to select the image processing target, and therefore security of information of the owner can be maintained.

Settings of the first application and the second application may be selected when the mobile terminal apparatus 5 is connected to the image processing apparatus 3 or in a “settings” function in advance (after downloading the operation application). For example, an application that permits display on the execution screen or an application that allows no display on the execution screen may be selected.

### (7) Operation Example of Mobile Terminal Apparatus 5

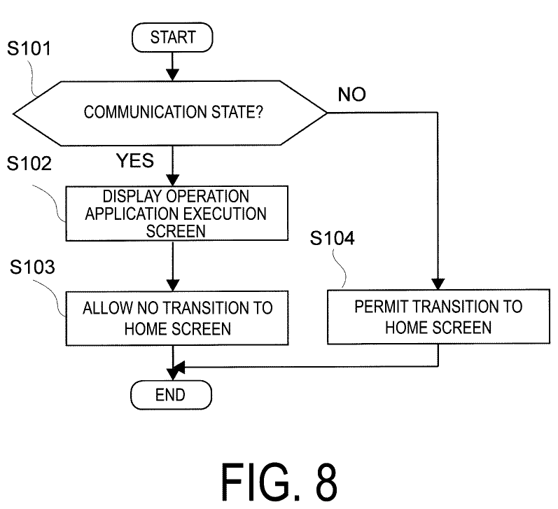

FIG. 8 to FIG. 11 are each a flowchart illustrating an operation example of restricting display of the image corresponding to the second application in the communication state in which communication connection between the communicator 510 of the mobile terminal apparatus 5 and the image processing apparatus 3 is established.

FIG. 8 is a flowchart illustrating a first operation example of restricting display of the image corresponding to the second application in the communication state in which communication connection between the communicator 510 of the mobile terminal apparatus 5 and the image processing apparatus 3 is established.

In the operation example of FIG. 8, the display 521 can display the home screen in which a plurality of icon image objects corresponding to a plurality of applications are arranged by the user in a selectable manner. In the communication state in which communication connection between the communicator 510 and the image processing apparatus 3 is established, the controller 540 causes the display 521 to display the operation screen corresponding to the operation application, and restricts transition from the operation screen to the home screen. According to such an operation example, operation on the home screen is restricted in the mobile terminal apparatus 5, and therefore security of information of the owner of the mobile terminal apparatus 5 can be secured.

In Step S101, the mobile terminal apparatus 5 determines the communication state with the image processing apparatus 3. When communication connection with the image processing apparatus 3 is established (Step S101; YES), the mobile terminal apparatus 5 displays the execution screen of the operation application in Step S102, and allows no transition to the home screen in Step S103. The processing of Step S103 corresponds to processing of allowing no display of the icon of the second application. On the other hand, when communication connection with the image processing apparatus 3 is not established (Step S101; NO), in Step S104, the mobile terminal apparatus 5 permits transition to the home screen.

In this manner, the operation of restricting display of the image corresponding to the second application of FIG. 8 is operation of performing control to not allow transition to the start (home) screen of the mobile terminal apparatus 5. Note that, when connection of the mobile terminal apparatus 5 with the image processing apparatus 3 is released, such restriction is no longer required. As an exception, when the mobile terminal apparatus 5 receives a phone call, for example, cancellation of such restriction may be enabled by a button.

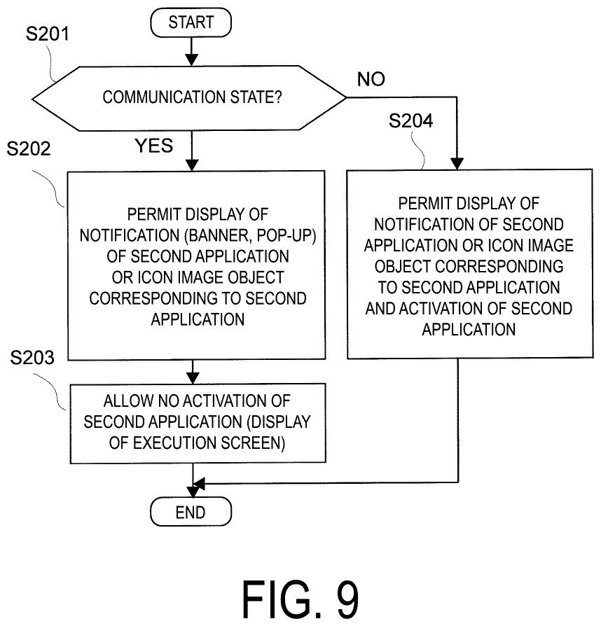

FIG. 9 is a flowchart illustrating a second operation example of restricting display of the image corresponding to the second application in the communication state in which communication connection between the communicator 510 of the mobile terminal apparatus 5 and the image processing apparatus 3 is established.

In the operation example of FIG. 9, in the communication state in which communication connection between the communicator 510 and the image processing apparatus 3 is established, the controller 540 allows no activation of the second application (no display of the execution screen). According to such an operation example, even when a person other than the owner of the mobile terminal apparatus 5 operates the image processing apparatus 3 using the mobile terminal apparatus 5, display of the execution screen of the second application not related to image processing is restricted, and therefore security of information of the owner can be secured.

In Step S201, the mobile terminal apparatus 5 determines the communication state with the image processing apparatus 3. When communication connection with the image processing apparatus 3 is established (Step S201; YES), in Step S202, the mobile terminal apparatus 5 permits display of a notification (a banner, a pop-up) of the second application or an icon image object corresponding to the second application, and in Step S203, the mobile terminal apparatus 5 allows no activation of the second application (display of the execution screen). The processing of Step S203 corresponds to processing of allowing no display of the execution screen of the second application. On the other hand, when communication connection with the image processing apparatus 3 is not established (Step S201; NO), in Step S204, the mobile terminal apparatus 5 permits display of the notification of the second application or the icon image object corresponding to the second application and activation of the second application.

In this manner, the operation of restricting display of the image corresponding to the second application of FIG. 9 is operation of enabling the notification (notification such as a banner or a pop-up) of the second application of the mobile terminal apparatus 5 but not allowing activation of the second application.

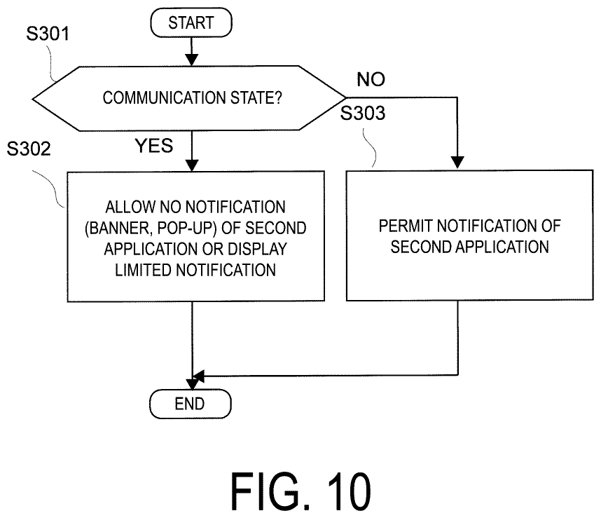

FIG. 10 is a flowchart illustrating a third operation example of restricting display of the image corresponding to the second application in the communication state in which communication connection between the communicator 510 of the mobile terminal apparatus 5 and the image processing apparatus 3 is established.

In the operation example of FIG. 10, in a non-communication state in which communication connection between the communicator 510 and the image processing apparatus 3 is not established, when a notification condition that the notification to the user is to be performed is satisfied in the second application, the controller 540 displays a notification image object representing the notification to the user, and in the communication state in which communication connection between the communicator 510 and the image processing apparatus 3 is established, even when the notification condition that the notification to the user is to be performed is satisfied in the second application, the controller 540 does not allow display of the notification image object. According to such an operation example, even when the notification condition is satisfied when a person other than the owner of the mobile terminal apparatus 5 operates the mobile terminal apparatus 5, it can be arranged that display of the notification image object is not allowed. Therefore, security of information of the owner of the mobile terminal apparatus 5 who operates the image processing apparatus 3 can be more securely secured.

In Step S301, the mobile terminal apparatus 5 determines the communication state with the image processing apparatus 3. When communication connection with the image processing apparatus 3 is established (Step S301; YES), in Step S302, the mobile terminal apparatus 5 allows no notification (a banner, a pop-up) of the second application or displays a limited notification. The processing of Step S302 corresponds to processing of allowing no display of the notification object by the second application. On the other hand, when communication connection with the image processing apparatus 3 is not established (Step S301; NO), in Step S303, the mobile terminal apparatus 5 permits the notification of the second application.

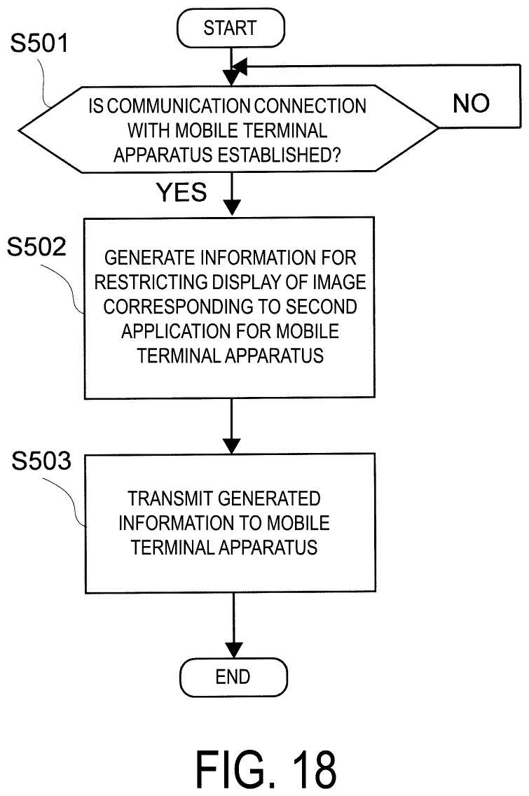

In this manner, the operation of restricting display of the image corresponding to the second application of FIG. 10 is operation of not even allowing the notification of the second application of the mobile terminal apparatus 5. Note that, instead of imposing restriction on display to such an extent, a notification with a reduced volume of information may be employed as will be described later with reference to FIG. 18.

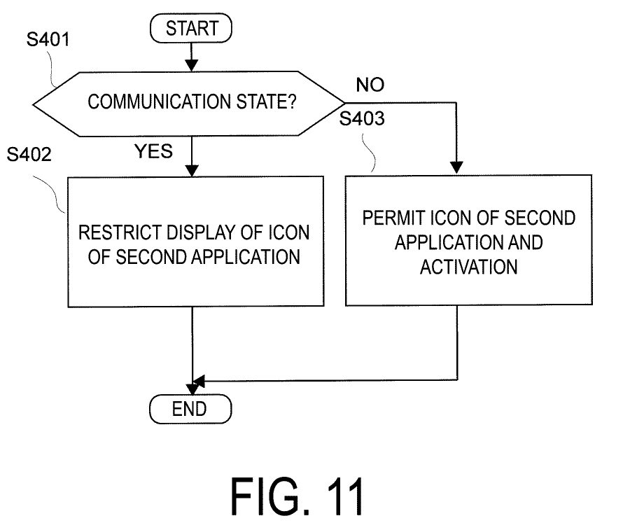

FIG. 11 is a flowchart illustrating a fourth operation example of restricting display of the image corresponding to the second application in the communication state in which communication connection between the communicator 510 of the mobile terminal apparatus 5 and the image processing apparatus 3 is established.

In the operation example of FIG. 11, the display 521 displays the home screen in which a plurality of icon image objects corresponding to a plurality of applications are arranged by the user in a selectable manner. In the communication state in which communication connection between the communicator 510 and the image processing apparatus 3 is established, the controller 540 may cause the icon image object corresponding to the first application to be selectable on the home screen, and cause the icon image object corresponding to the second application to not be selectable on the home screen. According to such an operation example, operation of the icon image object corresponding to the first application can be allowed, and activation of the second application based on operation of selecting the icon image object corresponding to the second application can be avoided. Therefore, security of information of the owner of the mobile terminal apparatus 5 who operates the image processing apparatus 3 can be more securely secured.

In Step S401, the mobile terminal apparatus 5 determines the communication state with the image processing apparatus 3. When communication connection with the image processing apparatus 3 is established (Step S401; YES), in Step S402, the mobile terminal apparatus 5 restricts display of an icon image of the second application and thereby cause the icon image to not be selectable on the home screen. On the other hand, when communication connection with the image processing apparatus 3 is not established (Step S401; NO), in Step S403, the mobile terminal apparatus 5 permits display of the icon of the second application.

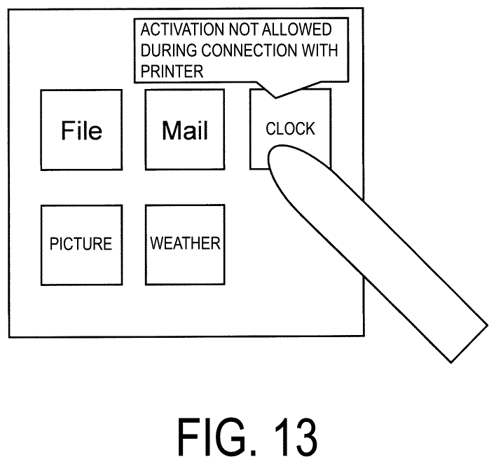

Note that, as the restriction of display of the icon of the second application in Step S402, in the communication state, the mobile terminal apparatus 5 may display the icon image object corresponding to the second application on the home screen, and cause the icon image object corresponding to the second application to not be selectable (an operation example of FIG. 13 to be described later and the like).

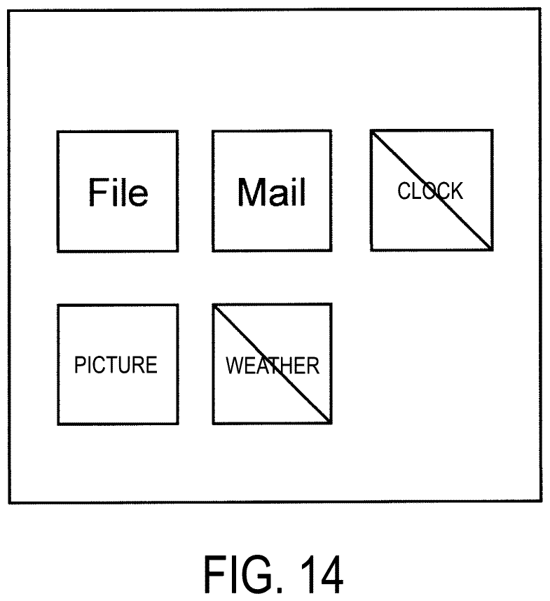

As the limitation of display of the icon of the second application in Step S402, in the communication state, the mobile terminal apparatus 5 may not allow display of the icon image object corresponding to the second application on the home screen (an operation example of FIG. 14 to be described later and the like).

### (8) Transition to Execution Screen of Printer Operation Application

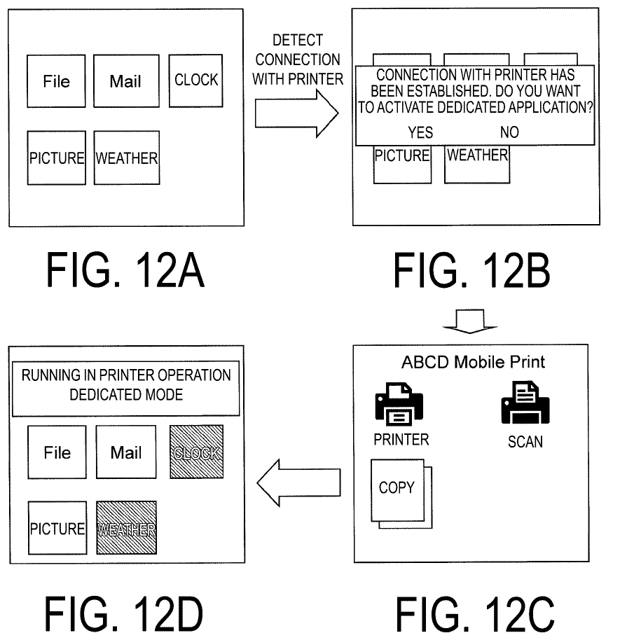

FIGS. 12A to 12D are diagrams illustrating a transition example of display screens of the mobile terminal apparatus 5 according to an embodiment. Here, FIG. 12A illustrates an example of the home screen. As illustrated in FIG. 12A, on the home screen, the icon image objects of “File”, “Mail”, “Clock”, “Picture”, and “Weather” are displayed. Each of “File”, “Mail”, and “Picture” is an example of the first application related to image processing, and is particularly an example of an application that handles image data as a printing target of the image processing apparatus 3. The image processing includes printing. The first application includes the operation application that handles the image data as the printing target of the image processing apparatus 3.

FIG. 12B illustrates an example of a notification when connection with the image processing apparatus 3 is established. When communication connection between the communicator 510 and the image processing apparatus 3 is established, the controller 540 of the mobile terminal apparatus 5 automatically activates the operation application or prompts the user to perform operation of launching the operation application. In the operation example of FIG. 12B, when communication connection between the communicator 510 and the image processing apparatus 3 is established, the controller 540 of the mobile terminal apparatus 5 prompts the user to perform operation of activating the operation application. According to such an operation example, a mode can be quickly transitioned to a mode of operating the image processing apparatus 3 by the mobile terminal apparatus 5, and therefore usability can be enhanced. In the operation example of FIG. 12B, after communication connection between the communicator 510 and the image processing apparatus 3 is established, the controller 540 of the mobile terminal apparatus 5 starts restriction of display of the image corresponding to the second application, in response to reception of predetermined operation from the user.

For example, when the mobile terminal apparatus 5 has connection established with the printer, that is, the image processing apparatus 3, a notification (FIG. 12B) indicating the establishment of connection is displayed on the home screen (FIG. 12A). Specifically, information “Connection with printer has been established. Do you want to activate dedicated application?” and information for prompting selection of one of “yes” or “no” are displayed as a pop-up window. Here, when “yes” is selected, the mobile terminal apparatus 5 activates the operation application.

FIG. 12C illustrates an example of the execution screen of the operation application. In the operation example of FIG. 12C, the communicator 510 of the mobile terminal apparatus 5 receives an identifier of the image processing apparatus 3 from the image processing apparatus 3. The controller 540 of the mobile terminal apparatus 5 determines the operation screen corresponding to the operation application and/or the first application, based on the identifier (printer ID). According to such an operation example, a screen suited for the image processing apparatus 3 can be displayed. For example, in FIG. 12C, the operation screen includes the icon image objects of “printer”, “scan”, and “copy”. This is because the printer ID of the image processing apparatus 3 includes information indicating that the image processing apparatus 3 has a printer function, a scan function, and a copy function. For example, although illustration is omitted, when the printer ID of the image processing apparatus 3 includes information indicating that the image processing apparatus 3 has only the printer function, the icon image object clearly displayed on the operation screen may be only the icon image object of “printer”, and the icon image objects of “scan” and “copy” need not be displayed on the operation screen or may be translucently displayed.

Note that identification information for identifying the printer ID of the image processing apparatus 3 may be stored in the storage 550 in advance, for example. As the identification information stored in the storage 550 in advance, a table of various printer IDs and reference information for identifying display screen data corresponding to the printer IDs of the table may be stored in advance. When connection is established with the image processing apparatus 3, the printer ID of the image processing apparatus 3 is acquired from the image processing apparatus 3, and the acquired identifier and the table are compared, and the display screen data may thus be identified.

FIG. 12D illustrates the home screen while the operation application is activated. When a screen transitions to the home screen while the operation application is activated, information “running in printer operation dedicated mode” is displayed on the home screen as a notification banner to inform the user that the operation application is being executed as a background job. On the home screen, the icon image objects corresponding to at least some of the second applications are grayed out (display thereof is restricted), and the second applications are not executed even when the icon image objects are selected. According to the operation example of FIG. 12D, display of the image corresponding to the application that handles the image data as the printing target is not restricted, and therefore the image data as the printing target can be selected, for example, and reduction of convenience for the user can be avoided.

Note that, although the operation example of FIG. 12D illustrates an example in which the second application not related to image processing is in a non-display state while the operation application is executed, the state may be changed from the non-display state to a display state through user authentication, such as password authentication or biometric authentication. The second application not related to image processing may be in an inoperable state while the operation application is executed.

Although the operation example of FIG. 12C illustrates an example in which a dedicated execution screen is displayed when the operation application is activated, this is not particularly restrictive. For example, when the operation screen is provided in the image processing apparatus 3, the operation screen of the image processing apparatus 3 may be mirrored for display.

Although the operation example of FIG. 12B illustrates an example in which user authentication such as password authentication or biometric authentication is not performed, user authentication such as password authentication or biometric authentication may be performed simultaneously.

### (9) Display Screen of Mobile Terminal Apparatus 5

Display screen examples of the mobile terminal apparatus 5 will be described with reference to FIG. 13 to FIG. 16.

### (9.1) Display Screen Example While Mobile Terminal Apparatus 5 and Image Processing Apparatus 3 Are Connected

FIG. 13 is a diagram illustrating an example of the display screen in the communication state in which connection between the mobile terminal apparatus 5 and the image processing apparatus 3 is established according to an embodiment. In the operation example of FIG. 13, in the communication state in which communication connection between the communicator 510 and the image processing apparatus 3 is established, the controller 540 of the mobile terminal apparatus 5 displays the icon image object corresponding to the second application on the home screen, and causes the icon image object corresponding to the second application to not be selectable. According to such an operation example, the second application is not granted a substantial execution authority. Therefore, security of information of the owner of the mobile terminal apparatus 5 who operates the image processing apparatus 3 can be more securely secured.

Specifically, although the icon image object corresponding to the clock application is selected, the clock application is the second application not related to image processing, and thus information “Activation not allowed during connection with printer” is displayed as a pop-up window. In this manner, in the communication state with the image processing apparatus 3, the mobile terminal apparatus 5 restricts display of the image corresponding to the second application (the execution screen of the second application). In other words, “to restrict display of the image corresponding to the second application” is not limited to restriction on the entire execution screen, but also includes allowing the icon image object to not be selectable as illustrated in FIG. 13.

### (9.2) Other Display Screen Example While Mobile Terminal Apparatus 5 and Image Processing Apparatus 3 Are Connected

FIG. 14 is a diagram illustrating another example of the display screen in the communication state in which connection between the mobile terminal apparatus 5 and the image processing apparatus 3 is established according to an embodiment. In the operation example of FIG. 14, in the communication state in which communication connection between the communicator 510 and the image processing apparatus 3 is established, the controller 540 of the mobile terminal apparatus 5 does not allow display of the icon image object corresponding to the second application on the home screen. According to such an operation example, in the mobile terminal apparatus 5, the opportunity to operate the icon image objects corresponding to the second applications (the icon image objects of the clock and the weather forecast) can be taken away from the user. Therefore, security of information of the owner of the mobile terminal apparatus 5 who operates the image processing apparatus 3 can be more securely secured. For example, in the application of the weather forecast, the area of residence of the owner of the mobile terminal apparatus 5 may be registered. For example, in the application of the clock, time of a country that the owner of the mobile terminal apparatus 5 frequently visits may be configured to be viewable. FIG. 14 illustrates an example in which the icon image object of the second application not related to image processing is not displayed (displayed with the icon image object being hatched) while the mobile terminal apparatus 5 and the image processing apparatus 3 are connected. In this case, the user cannot select the icon image object of the second application to activate the second application. Note that, while the mobile terminal apparatus 5 and the image processing apparatus 3 are connected, the icon image object of the second application not related to image processing may be grayed out, or may be completely removed from the execution screen. In this manner, in the communication state with the image processing apparatus 3, the mobile terminal apparatus 5 restricts display of the image corresponding to the second application (the execution screen of the second application). Here, “to restrict display of the image corresponding to the second application” only requires that no icon image object be selected to launch the second application, as described above. Thus, for example, the icon image object may be translucently displayed, and such an aspect is not limited to the example described above.

### (9.3) When Notification Condition Is Satisfied with Mobile Terminal Apparatus 5 and Image Processing Apparatus 3 Not Being Connected

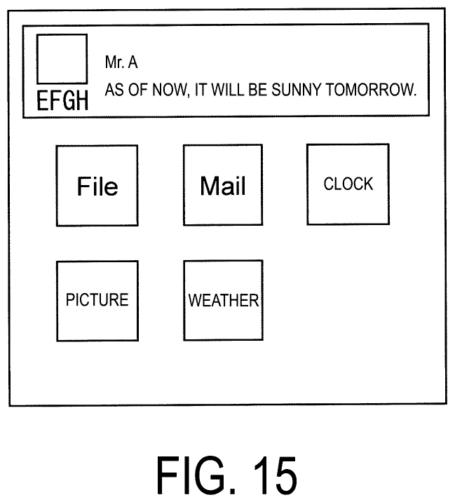

FIG. 15 is a diagram illustrating an example of the display screen when the notification condition is satisfied in the non-communication state in which connection between the mobile terminal apparatus 5 and the image processing apparatus 3 is not established according to an embodiment. In the operation example of FIG. 15, in the non-communication state in which communication connection with the image processing apparatus 3 is not established, when the notification condition that the notification to the user is to be performed is satisfied in the second application, the controller 540 of the mobile terminal apparatus 5 displays the notification image object representing the notification to the user. According to such an operation example, the notification is performed under a situation in which operation of the image processing apparatus 3 is not expected, and therefore usability of the mobile terminal apparatus 5 can be maintained. FIG. 15 illustrates an example in which information “Mr. A: As of now, it will be sunny tomorrow.” is displayed as a notification banner. In this manner, the notification banner is an image, specifically a notification image object, that corresponds to the second application not related to image processing. Thus, for example, when a person other than the owner of the mobile terminal apparatus 5 uses the mobile terminal apparatus 5 for operation of the image processing apparatus 3, it may be difficult to secure security of information of the owner of the mobile terminal apparatus 5, unless some limitation is imposed.

### (9.4) When Notification Condition Is Satisfied with Mobile Terminal Apparatus 5 and Image Processing Apparatus 3 Being Connected

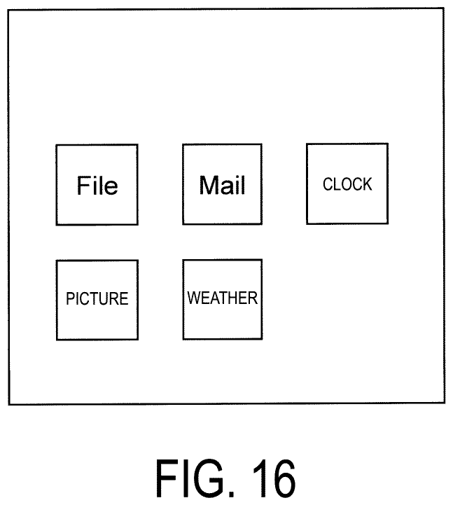

FIG. 16 is a diagram illustrating an example of the display screen when the notification condition is satisfied in the communication state in which connection between the mobile terminal apparatus 5 and the image processing apparatus 3 is established according to an embodiment. In the operation example of FIG. 16, even when the notification condition is satisfied in the second application, the controller 540 of the mobile terminal apparatus 5 does not allow display of the notification image object. According to such an operation example, even when the notification condition is satisfied when a person other than the owner of the mobile terminal apparatus 5 operates the mobile terminal apparatus 5, it can be arranged that display of the notification image object is not allowed. Therefore, security of information of the owner of the mobile terminal apparatus 5 who operates the image processing apparatus 3 can be more securely secured. Unlike FIG. 15, FIG. 16 illustrates an example in which no notification banner is displayed. In this manner, even when the notification condition is satisfied in the state in which the mobile terminal apparatus 5 is connected to the image processing apparatus 3, security of information of the owner of the mobile terminal apparatus 5 can be secured, provided that processing of restricting display of the image corresponding to the second application, such as the notification banner, is executed.

### (10) Operation Example

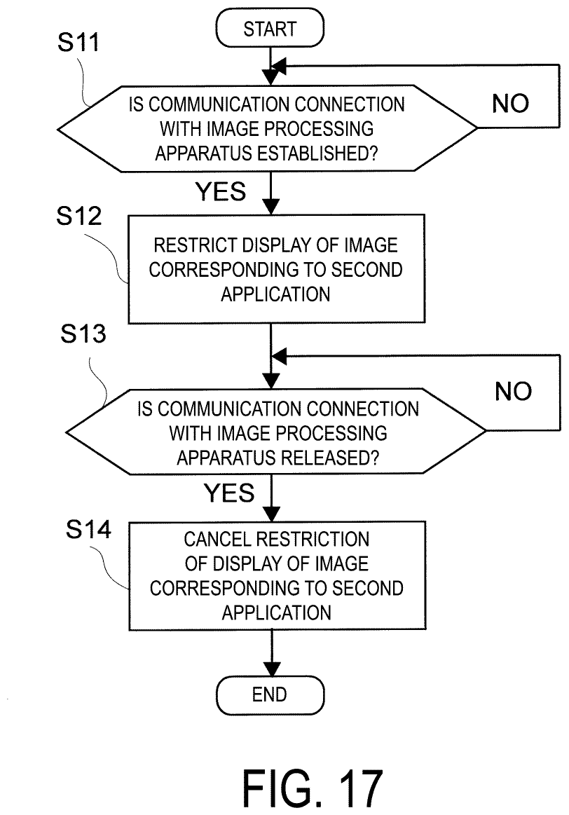

FIG. 17 is a flowchart illustrating an operation example of the operation support system according to an embodiment.

In Step S11, the mobile terminal apparatus 5 determines whether communication connection with the image processing apparatus 3 is established. When the mobile terminal apparatus 5 determines that communication connection with the image processing apparatus 3 is established, the processing of Step S11 proceeds to processing of Step S12. On the other hand, when the mobile terminal apparatus 5 determines that communication connection with the image processing apparatus 3 is not established, the processing of Step S11 continues. Note that the mobile terminal apparatus 5 may activate the operation application simultaneously with establishment of communication connection with the image processing apparatus 3. According to such operation, the image processing apparatus 3 can be operated from the mobile terminal apparatus 5.

In Step S12, the mobile terminal apparatus 5 restricts display of the image corresponding to the second application.

In Step S13, the mobile terminal apparatus 5 determines whether communication connection with the image processing apparatus 3 is released. When the mobile terminal apparatus 5 determines that communication connection with the image processing apparatus 3 is released, the processing of Step S13 proceeds to processing of Step S14. On the other hand, when the mobile terminal apparatus 5 determines that communication connection with the image processing apparatus 3 is not released, the processing of Step S13 continues. Note that the mobile terminal apparatus 5 may execute processing of determining whether operation of selecting an image object for release is performed, instead of the processing of determining whether communication connection with the image processing apparatus 3 is released in Step S13.

In Step S14, the mobile terminal apparatus 5 cancels restriction of display of the image corresponding to the second application, and ends the processing.

### (11) Variations

Although the embodiment described above has described an operation example in which the mobile terminal apparatus 5 initiates restriction of display of the image corresponding to the second application, this is not particularly restrictive. Here, an operation example will be described in which the image processing apparatus 3 initiates restriction of display of the image corresponding to the second application.

In the image processing apparatus 3 according to an embodiment, the communicator 312 communicates with the mobile terminal apparatus 5 capable of executing a plurality of applications including the first application related to image processing and the second application not related to image processing. The image processor 31 executes image processing, based on user operation on the mobile terminal apparatus 5. In the communication state in which communication connection with the mobile terminal apparatus 5 is established by the communicator 312, the controller 34 controls the communicator 312 to transmit, to the mobile terminal apparatus 5, information for restricting display of the image corresponding to the second application for the mobile terminal apparatus 5.

According to such an operation example, the image processing apparatus 3 can cause the mobile terminal apparatus 5 to restrict display of the image corresponding to the second application. Therefore, even when it is initiated by the image processing apparatus 3, security of the mobile terminal apparatus 5 can be secured.

Here, “to limit display” may be to transmit a “limitation command” to the mobile terminal apparatus 5, and to cause the terminal to execute display restriction. Thus, security can be secured.

Regarding “to restrict display”, the mobile terminal apparatus 5 may receive information (for example, the printer ID) required by the operation application in the mobile terminal apparatus 5 from the image processing apparatus 3, and the terminal may indirectly execute display restriction. Thus, security can be secured.

Regarding “to restrict display”, when the image processing apparatus 3 generates display data (remote screen) in the mobile terminal apparatus 5, the image processing apparatus 3 may generate limited display data, and the mobile terminal apparatus 5 may receive the restricted display data from the image processing apparatus 3. Thus, security can be secured.

For example, the following case is assumed: the mobile terminal apparatus 5 is loaded with processing of restricting display of the image corresponding to the second application depending on whether a limitation flag is set to 1, and further, the image processing apparatus 3 is also granted an authority to change the settings of the restriction flag. In such a case, as information for restricting display of the image corresponding to the second application, the image processing apparatus 3 may transmit, to the mobile terminal apparatus 5, flag information for setting the restriction flag to 1 together with the “printer ID”.

For example, the following case is assumed: the image processing apparatus 3 is also granted an authority to execute the processing of restricting display of the image corresponding to the second application. In such a case, as information for restricting display of the image corresponding to the second application, the image processing apparatus 3 may transmit, to the mobile terminal apparatus 5, a “control command” of restricting display of the image corresponding to the second application.

FIG. 18 is a flowchart illustrating an operation example of the image processing apparatus 3 according to a variation of an embodiment.

In Step S501, the image processing apparatus 3 determines whether communication connection with the mobile terminal apparatus 5 is established. When the image processing apparatus 3 determines that communication connection with the mobile terminal apparatus 5 is established, the processing of Step S501 proceeds to processing of Step S502. When the image processing apparatus 3 determines that communication connection with the mobile terminal apparatus 5 is not established, the processing of Step S501 continues.

In Step S502, the image processing apparatus 3 generates information for restricting display of the image corresponding to the second application for the mobile terminal apparatus 5.

In Step S503, the image processing apparatus 3 transmits the generated information to the mobile terminal apparatus 5, and the processing ends.

### (12) Other Variation

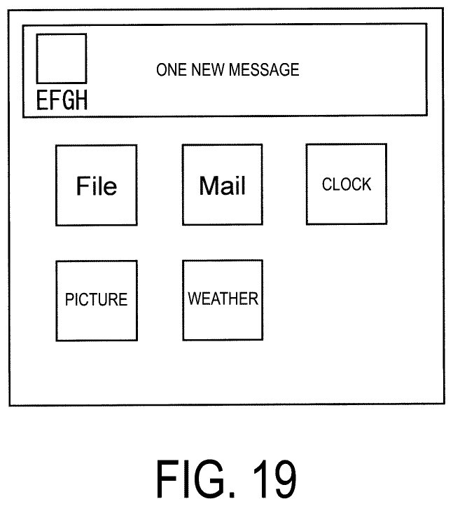

Although the embodiment described above has described an example in which the notification image object is not displayed as an example of the display screen when the notification condition is satisfied in the state in which the mobile terminal apparatus 5 is connected to the image processing apparatus 3, the display screen is not particularly limited to this. FIG. 19 is a diagram illustrating another example of the display screen when the notification condition is satisfied in the state in which the mobile terminal apparatus 5 is connected to the image processing apparatus 3 according to a variation of an embodiment. In the operation example of FIG. 19, in the non-communication state in which communication connection with the image processing apparatus 3 is not established, when the notification condition that the notification to the user is to be performed is satisfied in the second application, the controller 540 displays a first notification image object representing the notification to the user, and in the communication state in which communication connection with the image processing apparatus 3 is established, when the notification condition is satisfied, the controller 540 displays a second notification image object having a volume of information smaller than the first notification image object. According to such an operation example, even when the notification condition is satisfied while the image processing apparatus 3 is operated from the mobile terminal apparatus 5, the notification with a reduced volume of information can be performed, and therefore usability can be enhanced and security of information of the owner of the mobile terminal apparatus 5 can be secured.

Specifically, as the notification image object, a notification of only text information “one new message” is performed. In this manner, in an example of FIG. 19, a notification with a less volume of information is performed than that in the state in which the mobile terminal apparatus 5 is not connected to the image processing apparatus 3 (the state illustrated in FIG. 15). Note that the display need not be limited to display on the entire screen, and may be displayed in a partial region on the screen. In other words, the display may be performed with the volume of information indicated by the notification image object being reduced.

### (13) Other Variation

In the communication state in which communication connection between the mobile terminal apparatus 5 and the image processing apparatus 3 is established, the following operation can be performed.

The communicator 510 receives a job history associated with the mobile terminal apparatus 5 from the image processing apparatus 3, and the controller 540 causes the display 521 to display the job history, using the operation application. According to such an operation example, when the image processing apparatus 3 is operated from the mobile terminal apparatus 5, the job history related to the mobile terminal apparatus 5 can be referred to. Therefore, usability can be further enhanced.

For example, when the image processing apparatus 3 is operated from the mobile terminal apparatus 5 and the image processing apparatus 3 is caused to process a printing job, the image processing apparatus 3 records the printing job in the job history. Thus, for example, when the image processing apparatus 3 is operated from the mobile terminal apparatus 5 and a statement of medical expenses (receipt) is printed in a hospital, causing the display 521 to display the job history using the operation application can make it useful for management of receipts. If a third party unrelated to the user views such a job history, information of the receipt may be leaked; however, if restriction can be imposed on the display as in the present embodiment, such leakage of information can also be forestalled.

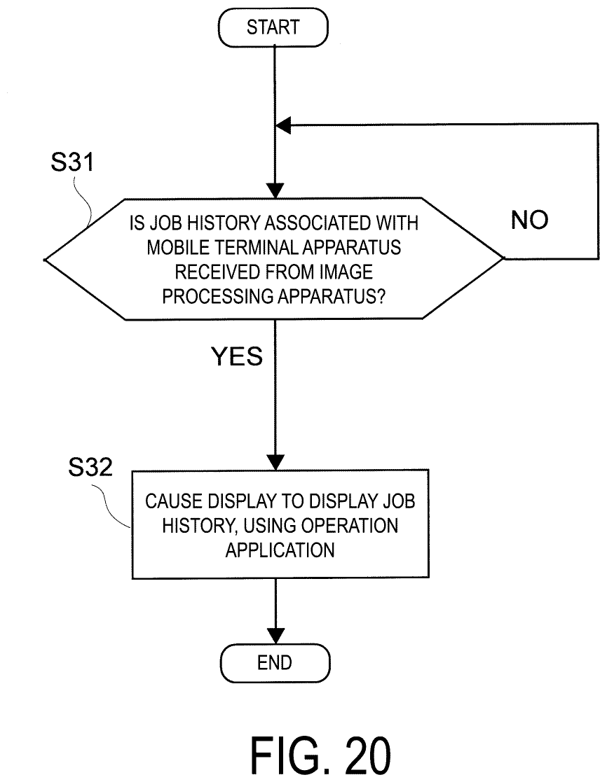

FIG. 20 is a flowchart illustrating an operation example of the mobile terminal apparatus 5 according to a variation of an embodiment.

In Step S31, the mobile terminal apparatus 5 determines whether the job history associated with the mobile terminal apparatus 5 is received from the image processing apparatus 3. When the mobile terminal apparatus 5 determines that the job history associated with the mobile terminal apparatus 5 is received from the image processing apparatus 3, the processing of Step S31 proceeds to processing of Step S32. On the other hand, a case when the mobile terminal apparatus 5 does not determine that the job history associated with the mobile terminal apparatus 5 is not received from the image processing apparatus 3, the processing of Step S31 continues.

In Step S32, the mobile terminal apparatus 5 causes the display 521 to display the job history, using the operation application, and ends the processing.

### (14) Other Variation

In the communication state in which communication connection between the mobile terminal apparatus 5 and the image processing apparatus 3 is established, the following operation can also be performed.

The image processing includes scanning, the second application includes an application that manages address information that can be used as a transmission destination of scanned data of the image processing apparatus 3, and the communicator 510 transmits the address information to the image processing apparatus 3. According to such an operation example, the image processing apparatus 3 can transmit the scanned data to the transmission destination specified by the address information. Thus, for example, the scanned data scanned by remotely operating the image processing apparatus 3 from the mobile terminal apparatus 5 can be transmitted to a destination registered as the address information of the mobile terminal apparatus 5.

In such an operation example as well, restriction can be imposed on the display, and therefore leakage of the address information including the personal information and leakage of the scanned data can be forestalled. For example, a sheet with sales information of a store written thereon can be scanned by remotely operating the image processing apparatus 3 from the mobile terminal apparatus 5, and the scanned data can also be transmitted to a transmission destination included in the address information registered in the mobile terminal apparatus 5. In this case as well, restriction can be imposed on the display, and therefore leakage of the sales information of the store to a third party can be forestalled. Only a person who sets the sheet with the sales information of the store written thereon to the image processing apparatus 3 may be secured and the registration of transmission destination information in the image processing apparatus 3 is not needed in advance, and therefore usability of the image processing apparatus 3 can also be enhanced.

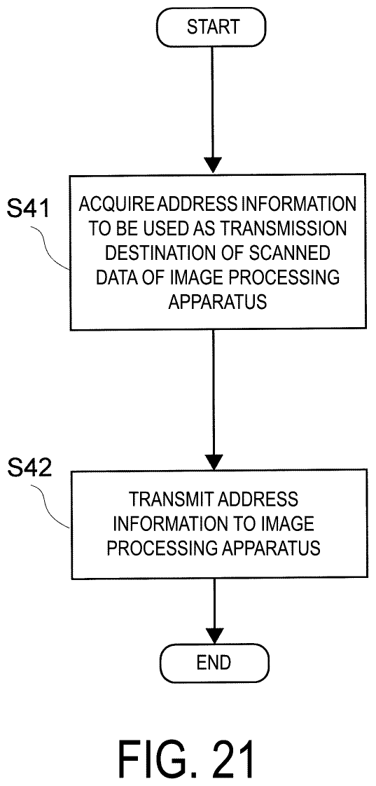

FIG. 21 is a flowchart illustrating another operation example of the mobile terminal apparatus 5 according to a variation of an embodiment.

In Step S41, the mobile terminal apparatus 5 acquires the address information that can be used as a transmission destination of scanned data of the image processing apparatus 3.

In Step S42, the mobile terminal apparatus 5 transmits the address information to the image processing apparatus 3, and ends the processing.

Note that the operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

The embodiments described above do not limit implementations only to an implementation as an operation support system. For example, the embodiments described above may include an implementation as a control method of a system such as an operation support system. For example, the embodiments described above may include an implementation as a program to be executed by a system such as an operation support system.

A program that causes the computer to perform operations according to the embodiments described above may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the apparatuses according to the embodiments described above may be integrated, and at least part of the apparatuses may be configured as a semiconductor integrated circuit (a chipset or an SoC).

The phrases “based on” and “depending on/in response to” used in the present disclosure do not mean “based only on” and “only depending on/in response to,” unless specifically stated otherwise. The phrase “based on” means both “based only on” and “based at least in part on”. Similarly, the phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (15) Supplements

Features relating to the embodiments described above are described below as supplements.

### Supplementary Note 1

A mobile terminal apparatus including:
a communicator configured to communicate with an image processing apparatus configured to perform image processing;
a controller configured to execute a plurality of applications comprising a first application related to the image processing and a second application not related to the image processing;
and
a display configured to display an image corresponding to an application being executed out of the plurality of applications,
wherein the first application comprises an operation application used for operation of the image processing, and
in a communication state in which communication connection between the communicator and the image processing apparatus is established, the controller restricts display of an image corresponding to the second application.

### Supplementary Note 2

The mobile terminal apparatus according to supplementary note 1, wherein the image processing comprises printing,
the first application further comprises an application that handles image data as a printing target of the image processing apparatus, and
the controller is configured to, in the communication state, restrict the display of the image corresponding to the second application without restricting display of an image corresponding to the first application.

### Supplementary Note 3

The mobile terminal apparatus according to supplementary note 1, wherein the display is configured to display a home screen in which a plurality of icon image objects corresponding to the plurality of applications are arranged and user-selectable, and
the controller is configured to, in the communication state, cause the display to display an operation screen corresponding to the operation application, and restricts transition from the operation screen to the home screen.

### Supplementary Note 4

The mobile terminal apparatus according to supplementary note 1, wherein
the display is configured to display a home screen in which a plurality of icon image objects corresponding to the plurality of applications are arranged and user-selectable, and
the controller is configured to, in the communication state, cause an icon image object of the plurality of icon image objects corresponding to the first application to be selectable on the home screen, and cause an icon image object of the plurality of icon image objects corresponding to the second application to not be selectable on the home screen.

### Supplementary Note 5

The mobile terminal apparatus according to supplementary note 4, wherein
the controller is configured to, in the communication state, display the icon image object corresponding to the second application on the home screen, and cause the icon image object corresponding to the second application to not be selectable.

### Supplementary Note 6

The mobile terminal apparatus according to supplementary note 4, wherein
the controller is configured to, in a state in which the communication connection is established, not allow display of the icon image object corresponding to the second application on the home screen.

### Supplementary Note 7

The mobile terminal apparatus according to supplementary note 1, wherein
the controller is configured to, in a non-communication state in which the communication connection is not established, when a notification condition to perform a notification to a user is satisfied in the second application, display a notification image object representing the notification to the user, and
in the communication state, even when the notification condition is satisfied in the second application, not display the notification image object.

### Supplementary Note 8

The mobile terminal apparatus according to supplementary note 1, wherein
the controller is configured to,
in a non-communication state in which the communication connection is not established, when
a notification condition to perform a notification to a user is satisfied in the second application, display a first notification image object representing the notification to the user, and
in the communication state, when the notification condition is satisfied, display a second notification image object having a smaller amount of information than the first notification image object.

### Supplementary Note 9

The mobile terminal apparatus according to supplementary note 1, wherein
the controller is configured to, when the communication connection is established, automatically activate the operation application or prompt a user to perform an activation operation of the operation application.

### Supplementary Note 10

The mobile terminal apparatus according to supplementary note 1, wherein
the controller is configured to, when the communication connection is disconnected, cancel the restriction.

### Supplementary Note 11

The mobile terminal apparatus according to supplementary note 1, wherein
the controller is configured to, after the communication connection is established, start the restriction, in response to reception of predetermined operation from a user.

### Supplementary Note 12

The mobile terminal apparatus according to supplementary note 8, wherein
the communicator is configured to receive an identifier of the image processing apparatus from the image processing apparatus, and
the controller is configured to determine an operation screen corresponding to the operation application and/or the first application, based on the identifier.

### Supplementary Note 13

The mobile terminal apparatus according to supplementary note 1, wherein
the controller is configured to cause the display to display an image object for cancellation for receiving user operation of canceling the restriction through user authentication.

### Supplementary Note 14

The mobile terminal apparatus according to supplementary note 1, wherein
the communicator is configured to receive a job history associated with the mobile terminal apparatus from the image processing apparatus, and
the controller is configured to cause the display to display the job history, using the operation application.

### Supplementary Note 15

The mobile terminal apparatus according to supplementary note 1, wherein
the image processing comprises scanning, the second application comprises an application that manages address information to be used as a transmission destination of scanned data of the image processing apparatus, and
the communicator is configured to transmit the address information to the image processing apparatus.

### Supplementary Note 16

The mobile terminal apparatus according to supplementary note 1, further including an operation inputter configured to receive an operation of a user,
wherein the controller is configured to cause the display to display a setting screen that receives the operation of the user for selecting the first application.

### Supplementary Note 17

An image processing apparatus including:
a communicator configured to communicate with a mobile terminal apparatus configured to execute a plurality of applications comprising a first application related to image processing and a second application not related to the image processing;
an image processor configured to execute the image processing, based on a user operation on the mobile terminal apparatus; and
a controller configured to control the communicator to transmit, to the mobile terminal apparatus, information for restricting display of an image corresponding to the second application for the mobile terminal apparatus, in a communication state in which communication connection with the mobile terminal apparatus is established by the communicator.

### Supplementary Note 18

A program causing a mobile terminal apparatus to execute:
communicating with an image processing apparatus configured to perform image processing;
executing any of a plurality of applications comprising a first application and a second application, the first application being an application related to the image processing and comprising an operation application used for operation of the image processing, and the second application being not related to the image processing;
displaying an image corresponding to an application being executed out of the plurality of applications; and
in a communication state in which communication connection between the communicator and the image processing apparatus is established, restricting display of the image corresponding to the second application.

1. A mobile terminal apparatus comprising:
a communicator configured to communicate with an image processing apparatus configured to perform image processing;
a controller configured to execute a plurality of applications comprising a first application related to the image processing and a second application not related to the image processing; and
a display configured to display an image corresponding to an application being executed out of the plurality of applications,
wherein the first application comprises an operation application used for operation of the image processing, and
in a communication state in which communication connection between the communicator and the image processing apparatus is established, the controller restricts display of an image corresponding to the second application.

2. The mobile terminal apparatus according to claim 1, wherein
the image processing comprises printing,
the first application further comprises an application that handles image data as a printing target of the image processing apparatus, and
the controller is configured to, in the communication state, restrict the display of the image corresponding to the second application without restricting display of an image corresponding to the first application.

3. The mobile terminal apparatus according to claim 1, wherein
the display is configured to display a home screen in which a plurality of icon image objects corresponding to the plurality of applications are arranged and user-selectable, and
the controller is configured to, in the communication state, cause the display to display an operation screen corresponding to the operation application, and restricts transition from the operation screen to the home screen.

4. The mobile terminal apparatus according to claim 1, wherein
the display is configured to display a home screen in which a plurality of icon image objects corresponding to the plurality of applications are arranged and user-selectable, and
the controller is configured to, in the communication state, cause an icon image object of the plurality of icon image objects corresponding to the first application to be selectable on the home screen, and cause an icon image object of the plurality of icon image objects corresponding to the second application to not be selectable on the home screen.

5. The mobile terminal apparatus according to claim 4, wherein
the controller is configured to, in the communication state, display the icon image object corresponding to the second application on the home screen, and cause the icon image object corresponding to the second application to not be selectable.

6. The mobile terminal apparatus according to claim 4, wherein
the controller is configured to, in a state in which the communication connection is established, not allow display of the icon image object corresponding to the second application on the home screen.

7. The mobile terminal apparatus according to claim 1, wherein
the controller is configured to,
in a non-communication state in which the communication connection is not established, when a notification condition to perform a notification to a user is satisfied in the second application, display a notification image object representing the notification to the user, and
in the communication state, even when the notification condition is satisfied in the second application, not display the notification image object.

8. The mobile terminal apparatus according to claim 1, wherein
the controller is configured to,
in a non-communication state in which the communication connection is not established, when a notification condition to perform a notification to a user is satisfied in the second application, display a first notification image object representing the notification to the user, and
in the communication state, when the notification condition is satisfied, display a second notification image object having a smaller amount of information than the first notification image object.

9. The mobile terminal apparatus according to claim 1, wherein
the controller is configured to, when the communication connection is established, automatically activate the operation application or prompt a user to perform an activation operation of the operation application.

10. The mobile terminal apparatus according to claim 1, wherein
the controller is configured to, when the communication connection is disconnected, cancel the restriction.

11. The mobile terminal apparatus according to claim 1, wherein
the controller is configured to, after the communication connection is established, start the restriction, in response to reception of a predetermined operation from a user.

12. The mobile terminal apparatus according to claim 8, wherein
the communicator is configured to receive an identifier of the image processing apparatus from the image processing apparatus, and
the controller is configured to determine an operation screen corresponding to the operation application and/or the first application, based on the identifier.

13. The mobile terminal apparatus according to claim 1, wherein
the controller is configured to cause the display to display an image object for cancellation for receiving a user operation of canceling the restriction through user authentication.

14. The mobile terminal apparatus according to claim 1, wherein
the communicator is configured to receive a job history associated with the mobile terminal apparatus from the image processing apparatus, and
the controller is configured to cause the display to display the job history, using the operation application.

15. The mobile terminal apparatus according to claim 1, wherein
the image processing comprises scanning,
the second application comprises an application that manages address information to be used as a transmission destination of scanned data of the image processing apparatus, and
the communicator is configured to transmit the address information to the image processing apparatus.

16. The mobile terminal apparatus according to claim 1, further comprising
an operation inputter configured to receive an operation of a user,
wherein the controller is configured to cause the display to display a setting screen that receives the operation of the user selecting the first application.

17. An image processing apparatus comprising:
a communicator configured to communicate with a mobile terminal apparatus configured to execute a plurality of applications comprising a first application related to image processing and a second application not related to the image processing;
an image processor configured to execute the image processing, based on a user operation on the mobile terminal apparatus; and
a controller configured to control the communicator to transmit, to the mobile terminal apparatus, information for restricting display of an image corresponding to the second application for the mobile terminal apparatus, in a communication state in which communication connection with the mobile terminal apparatus is established by the communicator.

18. A program causing a mobile terminal apparatus to execute:
communicating with an image processing apparatus configured to perform image processing;
executing any of a plurality of applications comprising a first application and a second application, the first application being an application related to the image processing and comprising an operation application used for operation of the image processing, and the second application being not related to the image processing;
displaying an image corresponding to an application being executed out of the plurality of applications; and
in a communication state in which communication connection with the image processing apparatus is established, restricting display of the image corresponding to the second application.
